(19) United States
(12) Patent Application Publication
(10) Pub. No.: US 2003/0053041 A1
(43) Pub. Date: Mar. 20, 2003

(54) Optical rader apparatus and distance measuring apparatus including the same

(76) Inventors: Emiko Isogai, Hekinan-shi (JP); Ryoichi Sugawara, Nagoya (JP)

Correspondence Address: LAW OFFICES OF DAVID G. POSZ, 2000 L STREET, N.W., SUITE 200, WASHINGTON, DC, 20036, US

(21) Appl. No.: 10/241,435

(22) Filed: Sep. 12, 2002

(30) Foreign Application Priority Data
Sep. 20, 2001 (JP) 2001-286773

(51) Int. Cl. G01C 3/08; G01C 1/00; G01B 11/26

(52) U.S. Cl. 356/4.01; 356/5.01; 356/141.1

(57) ABSTRACT

The scanner scans a first laser beam to have a first optical path. A concave mirror collects a second laser beam reflected by a reflective object. A photosensitive element receives the laser beam from the concave (parabolic) mirror to output a photosensitive signal. The photosensitive element is arranged outside a second optical path from the reflective object in the first optical path to the concave mirror. A segment concave mirror of which maximum size is such that a general concave mirror with a full circle aperture is divided on a plane including an optical axis of the concave mirror may be used. The photosensitive element is arranged near the optical axis to place the photosensitive element outside the second optical path to increase a light receiving efficiency. The distance measuring apparatus includes the optical radar scanner.

### BACKGROUND OF THE INVENTION

1. Field of the Invention

This invention relates to an optical radar apparatus for scanning a laser beam and receiving the laser beam reflected by a reflective object and a distance measuring apparatus including the same for measuring a distance to the reflective object.

2. Description of the Prior Art

Optical radar apparatuses for intermittently emitting and scanning a laser beam over a predetermined field in front of a vehicle and receiving the laser beam reflected by a reflective object are known. This type of apparatus is usable for a distance measuring apparatus for measuring a time difference between the emission and reception of the laser beams and calculating the distance to the reflective object. In order to obtain a wider detection field, a convex lens is used to collect the reflected laser beam the size of the photosensitive element becomes large, and thus the apparatus becomes costly.

To obtain a wider detection field with a small size of the photosensitive element, the focal length of the convex (plano-convex) lens and the distance between the convex lens and the photosensitive element should be shortened. However, this structure makes the diameter of the convex lens smaller because the radius of curvature should be made small. This reduces the magnitude of the detection signal, so that a sufficient detection field cannot be obtained.

To eliminate such a disadvantage, Japanese patent application provisional publication No. 5-257076 discloses a technique for collecting the reflected laser beam with a spherical mirror. More specifically, this discloses an optical scanning apparatus comprising a diagonal mirror reflecting a laser beam emitted along an optical axis from a laser diode to have a first optical path. The diagonal mirror is rotationally swung around the optical axis with a galvanometer. A spherical concave mirror under the diagonal mirror (on the opposite side of the laser beam reflected by the diagonal mirror) collects the reflected laser beam to focus the reflected laser beam on a photosensitive element which is fixed to the diagonal mirror, wherein the photosensitive element is arranged in the second optical path of the laser beam reflected by a reflective object to the spherical concave mirror. Thus, the diagonal mirror shades the laser beam reflected by the reflective object in front of the spherical concave mirror. This reduces the laser beam receiving efficient. Moreover, the galvanometer and the accompanying mechanism are required. Particularly, the shading makes a measurement impossible portion within the detection field. This provides disadvantage particularly in auto-cruising control for example.

Thus, it is required to provide an optical radar apparatus using a concave mirror with a high laser beam receiving efficiency.

### SUMMARY OF THE INVENTION

The aim of the present invention is to provide a superior optical radar apparatus for transmitting a scanning laser beam and receiving the reflected laser beam.

The aim of the present invention is to provide a superior distance measuring apparatus including the optical radar apparatus for measuring a distance to a reflective object.

According to the present invention, a first aspect of the present invention provides an optical radar apparatus comprising:

scanning means for emitting and scanning a first laser beam to have a first optical path; and

optical detection means including:

a concave mirror for reflecting and collecting a second laser beam reflected by a reflective object; and

a photosensitive element for receiving said second laser beam from said concave mirror to output a photosensitive signal, wherein said photosensitive element is arranged outside a second optical path from said reflective object in said first optical path to said concave mirror.

According to the present invention, a second aspect of the present invention provides the optical radar apparatus based on the first aspect, wherein said concave mirror comprises a segment concave mirror of which maximum size is such that a general concave mirror with a full circle aperture is divided on a plane including an optical axis of said concave mirror, and wherein said photosensitive element is arranged near said optical axis to place said photosensitive element outside said second optical path.

According to the present invention, a third aspect of the present invention provides the optical radar apparatus based on the second aspect, wherein said photosensitive element is arranged near a focal point of said segment concave mirror.

According to the present invention, a fourth aspect of the present invention provides the optical radar apparatus based on the third aspect, wherein said photosensitive element has a photosensitive plane which is arranged in parallel with said plane.

According to the present invention, a fifth aspect of the present invention provides the optical radar apparatus based on the first aspect, wherein said concave mirror is a parabolic mirror.

According to the present invention, a sixth aspect of the present invention provides the optical radar apparatus based on the first aspect, wherein said scanning means comprises a light emitting element printed circuit board for emitting said first laser beam, and said photosensitive element having a photosensitive element printed circuit board which is arranged perpendicularly to said light emitting element printed circuit board.

According to the present invention, a seventh aspect of the present invention provides the optical radar apparatus based on the first aspect, wherein said scanning means successively scans said first laser beam horizontally and vertically to have matrix scanning.

According to the present invention, an eighth aspect of the present invention provides a distance measuring apparatus comprising:

an optical radar unit including:

scanning means for intermittently emitting and scanning a first laser beam to have a first optical path; and

optical detection means including:

a concave mirror for reflecting and collecting a second laser beam reflected by a reflective object; and

a photosensitive element for receiving said second laser beam from said concave mirror to output a photosensitive signal;

time difference measuring means for measuring a time difference between when said scanning means emits said laser beam and when aid photosensitive element receives said second laser beam;

distance calculation means for calculating a physical quantity representing a distance to said reflective object on the basis of said measured time difference, wherein said photosensitive element is arranged outside a second optical path from said reflective object in said first optical path to said concave mirror.

According to the present invention, a ninth aspect of the present invention provides the distance measuring apparatus based on the eighth aspect, further comprising mounting means for mounting said distance measuring apparatus on a vehicle, wherein said scanning means successively scans said first laser beam in a width direction and a height direction of said vehicle.

### BRIEF DESCRIPTION OF THE DRAWINGS

The object and features of the present invention will become more readily apparent from the following detailed description taken in conjunction with the accompanying drawings in which:

FIG. 1A illustrates a distance measuring apparatus according to an embodiment of the present invention;

FIG. 1B illustrates a scanning and detection field according to the embodiment;

FIG. 2A is a perspective view of the parabolic mirror according to the embodiment;

FIG. 2B is a sectional view, taken on the line A-A′ in FIG. 2A, of the parabolic mirror according to this embodiment;

FIG. 3A illustrates comparison in a light receiving efficiency between this invention and the prior art when the focus spot is on the photosensitive element;

FIG. 3B illustrates comparison in a light receiving efficiency between this invention and the prior art when the focus spot slightly deviates from the photosensitive element; and

FIG. 4 illustrates a prior art distance measuring apparatus.

The same or corresponding elements or parts are designated with like references throughout the drawings.

### DETAILED DESCRIPTION OF THE INVENTION

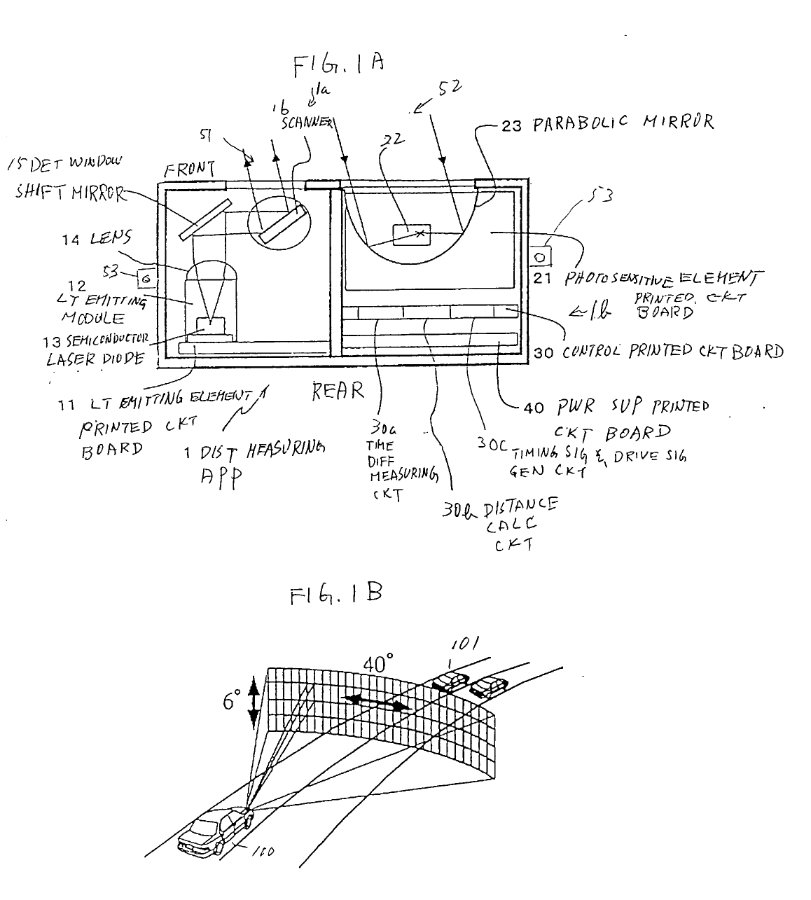

FIG. 1A illustrates a distance measuring apparatus 1 according to an embodiment of the present invention. The distance measuring apparatus 1 is mounted on a motor vehicle 100 to detect a reflective object such as a preceding motor vehicle 101 or obstacles or the like.

The distance measuring apparatus 1 comprises an optical radar unit 1a for emitting and scanning a laser beam and detecting the reflected laser beam and a distance calculation unit 1b for calculating the distance to the reflective object on the basis of the detected time difference. The distant calculation unit 1b includes, in a control printed circuit board 30, a time difference measuring circuit 30a for detecting the time difference between the emission of the laser beam and the detection of the reflected laser beam, a distance calculation circuit 30b for calculating a physical quantity representing a distance to the reflective object on the basis of the measured time difference, and a timing signal and drive signal generation circuit 30c.

The laser emitting side of the optical radar unit 1a includes a light emitting element printed circuit board 11, a light emitting module 12 on the light emitting element printed circuit board 11, a detection window shift mirror 15, and a scanner 16. The light emitting module 12 includes a semiconductor laser diode (hereinafter referred to as laser diode) 13 for emitting a pulse laser beam, a lens 14, and an aperture (not shown). The laser diode 13 is driven by a laser diode driving circuit (not shown) on the light emitting element printed circuit board 11 in response to a trigger signal from the timing signal and drive signal generation circuit 30c. The light emitting printed circuit board 11 and the control printed circuit board 30, etc. are supplied with a supply power from the power supply printed circuit board 40.

The laser beam emitted by the light emitting module 12 is directed to the detection window shift mirror 15 which reflects and directs the laser beam from the light emitting module 12 to the scanner 16 which scans (deflects) the laser beam from the detection window shift mirror 15 in front of the vehicle 100. The distance measuring apparatus 1 is mounted on the vehicle 100 with mounting members 53.

FIG. 1B illustrates a scanning and detection field of vertical six degrees and horizontal 40 degrees. The scanner 16 scans the laser beam over 40 degrees horizontally (in the width direction of the vehicle 100) to provide a wide field and sufficient horizontal resolution. For example, a small magnet fixed to the mirror of the scanner 16 is actuated with a coil which is driven by the timing signal and drive signal generation circuit 30c.

The detection window shift mirror 15 provides the vertical scanning of six degrees (in the height direction of the motor vehicle 100). The laser beam emitted by the laser diode 13 transmits through the aperture to have a rectangular cross-sectional shape. This beam transmits through the lens 14 to make the cross-sectional rectangular of the beam thinner to have a two degree of vertically spreading angle.

The scanner 16 further scans the laser beam from the detection window shift mirror 15 vertically. For example, a galvanometer mirror rotationally swinging around a vertical axis provides the horizontal scanning. The whole of the galvanic mirror is further rotationally swung around the horizontal axis. Moreover, instead the galvanometer mirror, a polygonal mirror unit is usable. In this case, the whole of the polygonal mirror unit is rotationally swung around an axis in addition of rotation of the polygonal mirrors to provide two-dimensional scanning.

Moreover, according to this embodiment, if necessary, an inclination angle of the detection window shift mirror 15 is adjusted to direct the center of the scanning field to a preceding vehicle 101 to trace the preceding vehicle 101.

The receiving side of the optical radar unit 1a includes a photosensitive element printed circuit board 21, the photosensitive element 22 on the photosensitive element printed circuit board 21, and a parabolic mirror 23. The laser beam reflected by a reflective object collected by the parabolic mirror 23 is received by the photosensitive element 22 on the photosensitive element printed circuit board 21. The photosensitive element 22 includes photodiodes (PD) arranged in a matrix to receive the pulsate magnitude variation of the received laser beam and outputs a detection signal (photosensitive signal).

The detection signal from the photosensitive element 22 is supplied to the time difference measuring circuit 30a through an amplifier (not shown). Moreover, before inputting the detection signal into the amplifier, it is also possible to amplify the detection signal with an STC circuit (not shown) to have a predetermined level at its output. The STC circuit is favorable in this embodiment to adjusts the magnitude of the received laser beam if a reflector with a high reflectance exists near the vehicle 100 because the magnitude of the received laser beam is in inverse proportional to the fourth power of distance to the target object.

The time difference measuring circuit 30a is supplied with the trigger signal (start pulse PA) also supplied to the laser diode driving circuit (not shown). Moreover, the detection signal of the received laser beam is supplied thereto as a stop pulse PB. The time difference between the start pulse PA and the stop pulse PB is coded into binary data. For example, a clock signal is counted in response to the start pulse PA and the count is stopped in response to the stop pulse PB.

This binary data is supplied to the distance calculation circuit 30b. The time difference measuring circuit 30a has a vary high resolution and can detect a plurality of reception pulses derived from one emission laser beam pulse and outputs a plurality of time difference values. This function is referred to as “multi-rapping” and the data obtained in this way is referred to as “multi-rapped data”. The distance calculation circuit 30b calculates the distance and the direction on the basis of the time difference data from the time difference measuring circuit 30a and the scanning angles of the laser beam from the timing signal and drive signal generation circuit 30c.

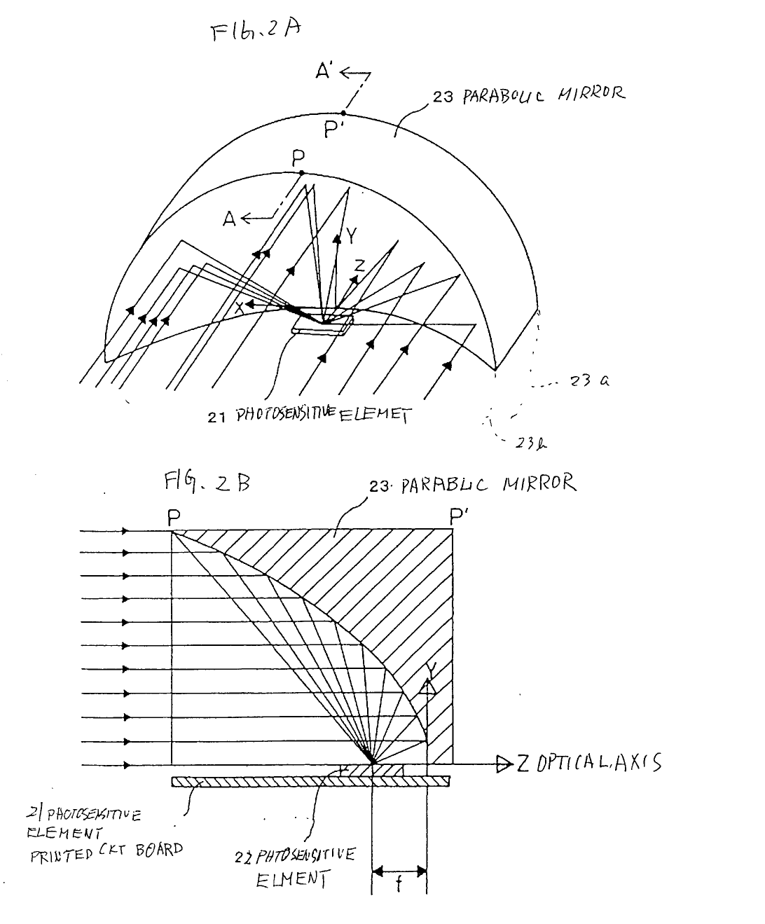

The parabolic mirror 23 will be described with reference to FIGS. 2A and 2B.

The specification of the parabolic mirror 23 is as follows:

The general expression of the parabolic mirror 23 is given by:

Z=C₁h²/[1+[1−(1+k)C₁h²]^{½}]

where

Z is a distance from a tangent plane at the vertex of the concave mirror.

h is a height from the optical axis.

C₁ is a curvature (1/R₁) at the vertex (origin) of the concave mirror.

R₁ is a radius of curvature at the vertex of the concave mirror.

k is a conic constant.

This general expression, where the radius of curvature R₁=9 (mm), and the conic constant k=−1, is for the parabolic mirror 23 in this embodiment. Actually, a segment parabolic mirror 23 is used. The segment parabolic mirror 23 is obtained by dividing the full circle aperture parabolic mirror 23a on the plane (A-A′) including the optical axis of the full circle aperture parabolic mirror 23a and segment parabolic mirror 23. In other words, a concave mirror has an optical axis and comprises a segment concave mirror having an optical axis. The segment concave mirror is waxed to or less than the plane (A-A′) including the optical axis Z (Z axis). In FIGS. 2A and 2B, X axis corresponds the width direction of the vehicle 100 and Y axis corresponds the height of the vehicle 100. The full circle aperture concave mirror 23a is divided on the X-Z plane.

The photosensitive element 21 receives the laser beam collected by the segment parabolic mirror 23 and is arranged such that the center thereof agrees with the focal point of the segment parabolic mirror 23 and the light receiving plane is arranged in parallel with the X-Z plane. In this embodiment, the distance f between the vertex and the focal point of the segment parabolic mirror 23 is 4.5 mm (f=4.5 mm). The photosensitive element 21 has a size of length 3 mm by width 5 mm and its photosensitive plane is arranged such that the length side agrees with the optical axis Z.

Thus, the photosensitive element printed circuit board 21 is also in parallel with the X-Z plane. On the other hand, the light emitting element printed circuit board 11 supporting the laser diode 13 is arranged in parallel with the X-Y plane. Accordingly the photosensitive element printed circuit board 21 is perpendicular to the light emitting element printed circuit board 11.

In operation, the timing signal and drive signal generation circuit 30c generates the trigger signal periodically. The laser diode 13 emits the laser beam pulse in response to the trigger signal. The scanner 16 scans the laser beam within the scanning field.

The segment parabolic mirror 23 receives the laser beam reflected by a reflective object and focus the laser beam on the photosensitive element 22. The photosensitive element 22 converts the received laser beam into a voltage corresponds to the magnitude of the received laser beam. This detection signal is supplied to the time difference measuring circuit 30a. The time difference measuring circuit 30a measures the time difference between the trigger signal and the reception timing of the reflected laser beam, wherein if there are a plurality of reflected pulses derived from a laser beam, the time difference detection circuit 30a outputs respective time difference values as multi-rapped data. The time difference data is supplied to the distance calculation circuit 30b to calculate the distance data. The distance data is stored in a RAM (not shown). The time difference data is converted into accurate time difference data in consideration of the delay in the photosensitive element 22. The distance data is obtained from the converted time difference data and the velocity of light. Here, the output of this distance measuring apparatus 1 may be a physical quantity corresponding the distance instead the distance data. For example, the time difference can represent the distance itself. That is, the delay from the trigger signal to the reception of the laser beam is in proportional to the distance, so that the time difference data can be used as a physical quantity representing the distance data. Here, the accurate distance data and accurate time difference data is calculated when the distance calculation circuit 30b receives the data from the time difference measuring circuit 30a.

The optical radar apparatus of this embodiment has following advantage effects.

(1) In this embodiment, the laser beam reflected from the reflective object is collected or focused on the photosensitive element 22 that is arranged outside the optical path from the reflective object to the parabolic mirror 23. Thus, the parabolic mirror 23 has a wide field capable of providing a necessary aperture diameter, but it does not stop the optical path. This improves the light receiving efficiency. Particularly, in this embodiment, because the optical radar apparatus is applied to a distance measuring apparatus 1, it is necessary to detect a weak (a low intensity) light, and there is a basic need for avoiding decrease in the light receiving efficiency. Moreover, if the photosensitive element 22 is so arranged to shadow the optical path, this may disable to detect the reflective object in that direction. Thus, the structure that does not stop the optical path is effective.

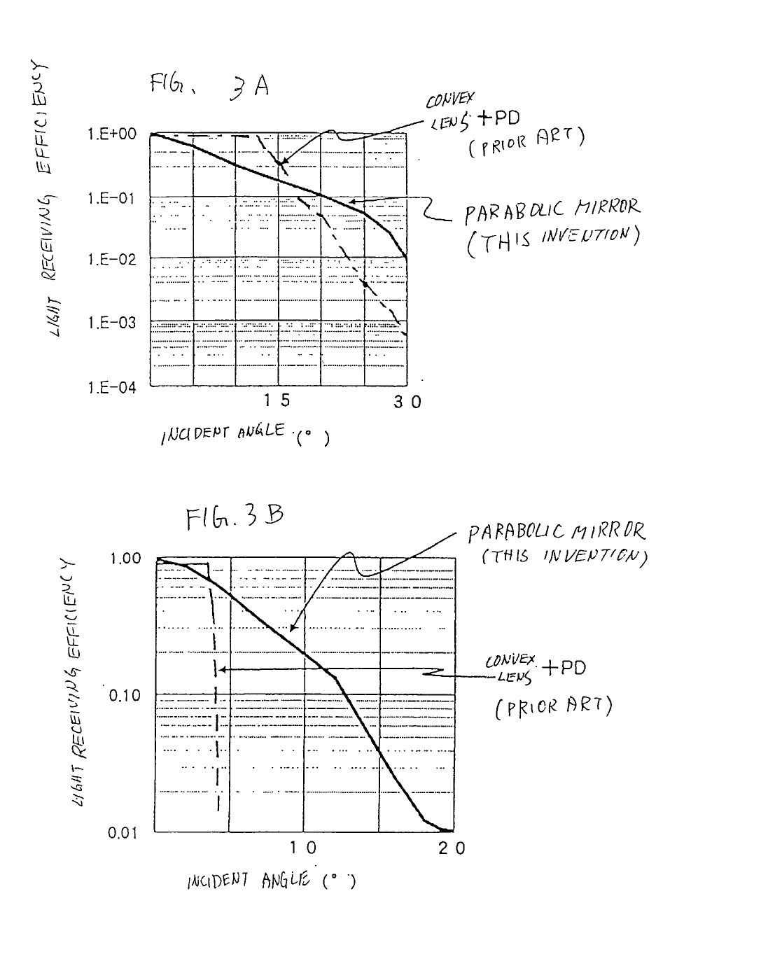

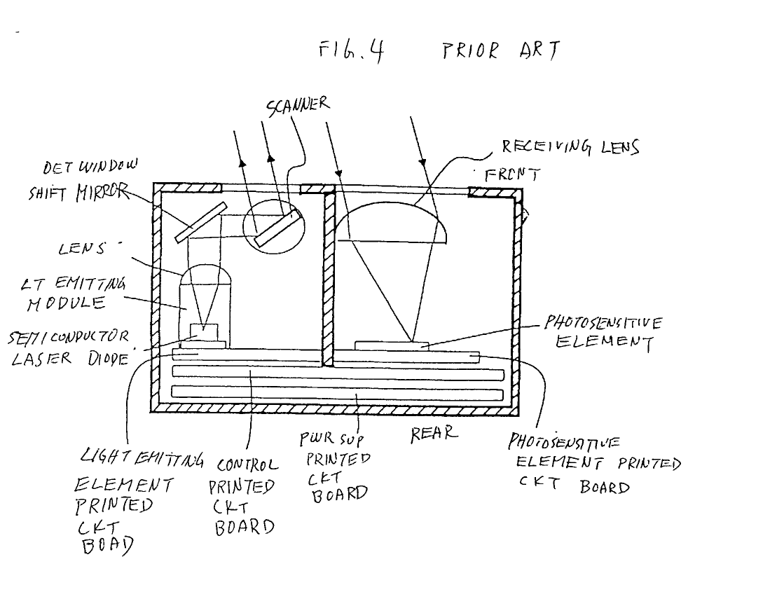

FIG. 3A illustrates comparison in light collecting efficiency (light receiving efficiency) with respect to the incident angle (field angle) with the parabolic mirror 23 and a photosensitive element (3 mm×5 mm) and with a convex lens and a photosensitive element (3 mm×12 mm).

Moreover, the structure according to this embodiment is simpler than that using the convex (plano-convex) lens. Further, the parabolic mirror comprises a segment parabolic mirror 23 of which maximum size is such that a general parabolic mirror 23a with a full circular aperture 23b is divided on the plane including the optical axis Z of the parabolic mirror 23. The photosensitive element 22 is arranged near the optical axis Z to place the photosensitive element 22 outside the second optical path 52 from the reflective object in the first optical path 51 to the parabolic mirror 23. Thus, the space efficiency is relative high.

In this embodiment, two-dimensional scanning is used. With this structure, the parabolic mirror 23 can have a broader field in the vertical direction than that by the prior art case using the convex lens. That is, the focus spot of the prior art convex lens is sharp. On the other hand, the focus spot of the parabolic mirror 23 is relatively unclear. For example, in the case of the prior art convex lens, when the focus spot becomes outside the photosensitive element 22, the photosensitive element 22 cannot receive the beam. On the other hand, in the case of the parabolic mirror 23, the photosensitive element 22 can receive a portion of the received beam though the focus spot is slightly outside the photosensitive element.

(2) Moreover, the photosensitive element 22 is arranged near the focus point position of the parabolic mirror 23. Further, the photosensitive plane of the photosensitive element 22 is arranged in parallel with the plane including the optical axis Z of the parabolic mirror 23, so that the intensity of the laser beam received by the photosensitive element 22 is relatively large. In addition, incident angles of light components reflected respective portions of the surface of the parabolic mirror 23 converge within a suitable range.

(3) This embodiment provides the following advantage effects with the parabolic mirror 23 out of concave mirrors.

If the focal length is relative long, the receiving spot becomes large. Thus, the size of the photosensitive element should be made large. Then, a short focal length is advantageous. As describe in this embodiment, the use of the parabolic mirror with a relative broad field is considered to be more advantageous than the simple spherical mirror if the optimum resolution of focus points is obtained, which makes the distance from the reflection to the receiving element shorter as possible as.

(4) The photosensitive element printed circuit board 22 is arranged perpendicularly to the light emitting element printed circuit board 11. This provides the following advantage effects. That is, because the light emitting element printed circuit board 11 generates high speed pulses, it emits high frequency electromagnetic noise. In addition, the light emitting element printed circuit board 11 and the photosensitive element printed circuit board 21 may be shielded with walls or the like. However, shielding may be frequently insufficient. Moreover, there is a need to reduce the cost by removing walls. Further, in this embodiment, the optical radar apparatus is applied to the distance measuring apparatus 1, so that the light emitting element printed circuit 11 generates a relative high power (for example, 10-20 W). On the other hand, the photosensitive element printed circuit 21 has a very high sensitivity because a very small magnitude signal is inputted thereto. Thus, receiving radio waves in a vertical position gives a severe affection. Then, receiving radio wave horizontally by the photosensitive element printed circuit board 21 reduces the adverse affection. Here, it is general that loops on the printed circuit board form coils that receive radio waves. Then, the arrangement of the light emitting element printed circuit board 11 perpendicular to the photosensitive element printed circuit board 21 can reduce the affection of noise.

In this embodiment, the laser diode 13, the detection window shift mirror 15, and the scanner 16 or the like correspond the scanning means. The parabolic mirror 23 and the photosensitive element 22 correspond the optical detection means. Moreover, the time difference measuring circuit 30a corresponds the time difference measuring means, and the distance calculation circuit 30b corresponds the distance calculation means.

The distance measuring apparatus 1 is unlimited to the above-mentioned embodiment, and can be modified as follows:

(a) In the above-mentioned embodiment, the distance measuring apparatus 1 for a vehicle have been described. However, this sensing structure can be applied to measurement other than the distance measurement.

(b) In the above-mentioned embodiment, the parabolic mirror 23 is used as an example of a concave mirror. However, it is possible to use concave mirrors other than the parabolic mirror 23. Moreover, the parabolic mirror 23 of which maximum size is such that a general concave mirror with a full circular aperture is divided on a plane including an optical axis of the parabolic mirror 23. Moreover, the smaller segment parabolic mirror can be used. In the (half) parabolic mirror 23, the photosensitive element 22 can be arranged without stopping the optical path, and the area receiving the reflection beam is wider. Thus, this is advantageous in the light receiving efficiency. However, a full circular aperture concave mirror can be used with the photosensitive element 22 is arranged on the plane including the optical axis. In this case, there is an unused half portion of the concave mirror but operable.

(c) In the above-mentioned embodiment, the laser beam is two-dimensionally scanned. However, this embodiment is applicable to one-dimensional scanning.

What is claimed is:

1. An optical radar apparatus comprising:
scanning means for emitting and scanning a first laser beam to have a first optical path; and
optical detection means including:
a concave mirror for reflecting and collecting a second laser beam reflected by a reflective object; and
a photosensitive element for receiving said second laser beam from said concave mirror to output a photosensitive signal, wherein said photosensitive element is arranged outside a second optical path from said reflective object in said first optical path to said concave mirror.

2. The optical radar apparatus as claimed in claim 1, wherein said concave mirror comprises a segment concave mirror of which maximum size is such that a general concave mirror with a full circle aperture is divided on a plane including an optical axis of said concave mirror, and wherein said photosensitive element is arranged near said optical axis to place said photosensitive element outside said second optical path.

3. The optical radar apparatus as claimed in claim 2, wherein said photosensitive element is arranged near a focal point of said segment concave mirror.

4. The optical radar apparatus as claimed in claim 3, wherein said photosensitive element has a photosensitive plane which is arranged in parallel with said plane.

5. The optical radar apparatus as claimed in claim 1, wherein said concave mirror is a parabolic mirror.

6. The optical radar apparatus as claimed in claim 1, wherein said scanning means comprises a light emitting element printed circuit board for emitting said first laser beam, and said photosensitive element having a photosensitive element printed circuit board which is arranged perpendicularly to said light emitting element printed circuit board.

7. The optical radar apparatus as claimed in claim 1, wherein said scanning means successively scans said first laser beam horizontally and vertically to have matrix scanning.

8. A distance measuring apparatus comprising:
an optical radar unit including:
scanning means for intermittently emitting and scanning a first laser beam to have a first optical path; and
optical detection means including:
a concave mirror for reflecting and collecting a second laser beam reflected by a reflective object; and
a photosensitive element for receiving said second laser beam from said concave mirror to output a photosensitive signal;
time difference measuring means for measuring a time difference between when said scanning means emits said laser beam and when aid photosensitive element receives said second laser beam;
distance calculation means for calculating a physical quantity representing a distance to said reflective object on the basis of said measured time difference, wherein said photosensitive element is arranged outside a second optical path from said reflective object in said first optical path to said concave mirror.

9. The distance measuring apparatus as claimed in claim 8, further comprising mounting means for mounting said distance measuring apparatus on a vehicle, wherein said scanning means successively scans said first laser beam in a width direction and a height direction of said vehicle.
